(19) United States
(12) Patent Application Publication
(10) Pub. No.: US 2011/0288898 A1
(43) Pub. Date: Nov. 24, 2011

(54) Coordinating Services

(75) Inventor: John Roe, Cambridge (GB)

(73) Assignee: NOKIA CORPORATION, Espoo (FI)

(21) Appl. No.: 13/001,967

(22) PCT Filed: Jun. 26, 2009
(86) PCT No.: PCT/IB2009/006093

§ 371 Date: Mar. 31, 2011

(30) Foreign Application Priority Data
Jun. 27, 2008 (GB) 0811840.8

(51) Int. Cl. G06F 15/173; G06Q 10/00

(52) U.S. Cl. 705/7.13; 709/224

(57) ABSTRACT

The use of one or more services in a computer system is scheduled so as to limit the overall system cost. The scheduling is based upon information concerning the fixed and incremental components of the cost of using the service, and a set of clients to which the service is available.

### FIELD OF THE INVENTION

This invention relates to a method of managing use of a service in a computer system so as to limit the overall system cost.

### BACKGROUND OF THE INVENTION

The term computing device’ as used herein is to be expansively construed to cover any form of electrical device and includes: data recording devices, such as digital still and movie cameras of any form factor, computers of any type or form; including hand held and personal computers; communication devices of any form factor, including mobile phones, smart phones, communicators which combine communications, image recording and/or playback, and computing functionality within a single device; and other forms of wireless and wired information devices.

The term ‘computer system’ as used herein is to be expansively construed to cover any arrangement of one or more computing device, for example a single device or several devices networked together. The computer system may additionally include components other than computing devices.

Most computing devices operate under the control of an operating system. The operating system can be regarded as the software that enables all the programs to be run on the computing device and a key component to greater operating efficiency and easier application development.

An operating system manages the hardware and software resources of the computing device in which it is installed. These resources include such things as the central processor unit (CPU), memory, and disk space, if a disk forms part of or is used in conjunction with the computing device. The operating system also enables and manages interaction between different software entities, such as application programs, drivers, etc., in the device. As such, the operating system provides a stable, consistent way for a component to use other hardware and software resources of the device without needing to know all the details of the physical resources available to the hardware.

The term ‘service’ is used herein to refer to a set of functionality that is provided in response to a request from a hardware or software element in the computing device. There are numerous possible services that can be provided to elements of the device and the term should therefore be interpreted broadly. The element requesting the service is referred to as the ‘client’ and an element that provides the service as the ‘service provider’. The service itself may be provided entirely by hardware and/or software elements of the device, or may be provided in whole or part by one or more remote devices.

For example, an application program running on a mobile phone may request that camera hardware in the phone capture an image and return it to the application program. Here, the functionality of capturing and returning the image is a service provided by the camera hardware. The element making the request for the service is the client. Other elements (for example a plurality of different application programs) can make similar requests for images to be captured and returned, and this service therefore has potential many clients.

The performance of a service inevitably comes with an associated cost. Common costs include physical overheads such as processor time and memory usage, which will affect the performance of the device and its capacity of perform other tasks at the same time. Because there are considerable financial pressures on the manufacture of modern computing devices (including portable devices such as mobile phones which are aimed at the price-sensitive mass market), it is desirable that such overheads are minimised in order to maximise performance without necessitating expensive additional or improved hardware.

Power consumption is a cost of interest in devices that have their own limited energy store (especially mobile devices using, for example, a battery or fuel cell). Each performance of a service will have an associated power consumption cost and it is highly desirable to minimise this in order to maximise the operable life of the device before the energy store must be replenished/replaced.

Related to power consumption is the cost of unwanted heat generation when performing the service. This is, for example, relevant in the case where the device is a portable device with a small form factor that restricts the provision of hardware dedicated to heat dissipation, such as heatsinks and fans. Similarly, it is undesirable that a device intended to be carried in a pocket (such as a mobile phone) and/or used in the operators hands should in operation become uncomfortably hot. Heat generation is also relevant for very processor-intensive tasks or tasks that are performed very frequently. Server farms, for example, require vast and extremely expensive cooling systems due to the huge number of service requests they frequently handle. Reducing the heat generated by a servers in a farm not only reduces the need for such cooling systems, but permits a denser arrangement of the servers within the farm.

For at least the reasons above, it is highly desirable to limit the overall system cost in computer systems.

### SUMMARY OF THE INVENTION

In a first embodiment, there is provided a method comprising: determining a fixed component of the cost associated with the use of a service in a computer system; determining an incremental component of the cost associated with the use of the service; determining a set of clients to which the service is available; and using the determined fixed and incremental components to schedule use of the service by the set of clients so as to control the overall system cost.

In a second embodiment, the present invention provides apparatus configured to perform the method of the first aspect.

In a third embodiment, the present invention provides apparatus comprising at least one processor; and at least one memory including computer program code, the at least one memory and the computer program code are configured to, working with the at least one processor, cause the apparatus to perform at least the following:
determine a fixed component of the cost associated with the use of a service in a computer system; determine an incremental component of the cost associated with the use of the service; determine a set of clients to which the service is available; and use the determined fixed and incremental components to schedule use of the service by the set of clients so as to control the overall system cost. Such apparatus may comprise a mobile computing device or, more specifically, a mobile telephone.

In a fourth embodiment, the present invention provides a computer program for: determining a fixed component of the cost associated with the use of a service in a computer system; determining an incremental component of the cost associated with the use of the service; determining a set of clients to which the service is available; and using the determined fixed and incremental components to schedule use of the service by the set of clients so as to control the overall system cost.

In a fifth embodiment, the present invention provides a computer readable medium having stored thereon the computer program of the fourth embodiment. Further disclosed is an apparatus comprising means for determining a fixed component of the cost associated with the use of a service in a computer system; means for determining an incremental component of the cost associated with the use of the service; means for determining a set of clients to which the service is available; and means for using the determined fixed and incremental components to schedule use of the service by the set of clients so as to control the overall system cost.

Fixed costs relate to the static costs that are associated with the use of a service and although incurred each time the service is used, will not vary between instances. Typically, fixed costs will include set-up costs such as those associated with loading drivers, opening connections, and initializing hardware. Incremental costs, on the other hand, relate to costs that are not fixed for every instance of the service, but instead vary according to the particular instance of the service. Sending data over a Wireless Local Area Network (WLAN), for example, will incur fixed costs associated with initializing the network hardware, and establishing the network connection. Further fixed cost may be incurred disconnecting from the WLAN after the data has been sent, and in restoring the wireless networking hardware to its idle state (e.g. shutting down the hardware, or putting it to sleep). The step of actually transmitting the data over the connection will have associated incremental costs, since the cost of performing the transmission will vary according to the amount of data that is being transmitted. Although in the WLAN example the cost will actually increment as more data is sent, the term ‘incremental cost’ ought to be construed more widely as cost that will vary according to usage, and may include variations other than a monotonically increasing cost.

The use of the service is scheduled to limit the total cost to the system. Determining both the fixed and the incremental cost of using the service allows this scheduling to be performed much more efficiently and more intelligently. This in turn enables the total system cost to be limited further and also more efficiently (by reducing the burden on the system due to the scheduling operation itself).

Determining and scheduling the use of the service by a set of clients may comprise doing so for a single client; however, the use of the service by multiple clients can also be scheduled. It is easier to schedule multiple uses of a service for a single client, since this scheduling may be performed by the client itself and therefore with a full knowledge of the client's present and intended use of the service. However, more effective limitation of the overall system cost can be achieved if the use of the service is scheduled across more than one client. This would be difficult to do within a single client since it is highly unlikely to have knowledge of the other clients' use of the service. It is therefore highly desirable to provide for centralised scheduling of the use of the service, for example by an operating system. By determining the usage of the service by more than one client, the most efficient schedule can be determined for the service's use by all of the clients.

There are many heuristics that can be applied to the scheduling and these may vary according to the nature of the limitation in overall system cost that is sought, as well as restrictions as to when particular or all instances of the service can be performed.

A preferred schedule for using a service is the clustering of multiple instances of the service's use, so as to share the fixed cost component over each of the clustered instances. Clustering instances of the service involves performing the instances contemporaneously or consecutively, depending on the nature of the service and the capabilities of the service provider. Performing multiple instances of the service at the same time, or immediately one after the other, will often allow steps with an associated fixed cost to be performed just once for the entire cluster. When five instances of a service are clustered together, this could provide an 80% reduction in this portion of the fixed cost component—a significant reduction in the overall system cost.

It is normally the case that costs across a system should be minimised and limiting the overall system cost therefore preferably comprises minimising the overall system cost. However, for certain costs and under certain circumstances it may be desirable to maintain the overall system cost at or particular levels or within particular ranges. Limiting the overall system cost may therefore alternatively comprise maintaining the overall system cost below a threshold (maximum) level, below which it may or may not be minimised. Similarly, the overall system cost may be limited to a particular range of values, for example between a minimum value and a maximum value, or (in rare circumstances) so as to exceed a minimum value. An example where maximising a cost would be desirable would be when testing a system for heat dissipation, or when a user desires an energy source to be drained more rapidly in anticipation of imminent recharging.

The overall system cost and the fixed and incremental costs may be a single type of cost, or may be a combination of several different cost types. For the reasons discussed above, costs that affect power consumption and system performance are particularly important when they are incurred in mobile devices. Exemplary types of cost include power consumption, reduction in the remaining usable life of an energy store (e.g. a battery); heat generation; processor time; memory usage; communication bandwidth usage; and financial cost (e.g. connection or data charges when using a communication network). In the case of the reduction in usable life of an energy store, this may be the remaining life of a single-use energy store (e.g. a conventional alkaline battery) or alternatively the remaining life of a rechargeable energy store before it needs to be recharged.

There are various methods according to which the scheduling can be implemented. According to one, requests from the set of clients for use of the service are queued before they are processed. The release of requests in the queue for processing is then controlled so to satisfy the limitation of the overall system cost.

Where it is desirable to cluster instances of service use together, requests may be queued until a threshold number of requests have been queued, at which point the queue is flushed, releasing all of the queued requests. Flushing the queue in this manner allows the requests to be processed together, either contemporaneously or consecutively depending upon their nature and the resources available.

When the service is of such a nature that its performance will never be timesensitive, filling and flushing a fixed-length queue in this manner will work well. However it is, in practice, often the case that a request for a service must be processed as soon as possible—for example when it originates from a user. User-originating requests will commonly require immediate processing, any significant delay being unacceptable to the user. An immediate request may therefore be processed as soon as it enters the queue, or may skip the queue altogether.

Whilst some requests may require immediate processing, it is not necessarily the case that scheduling can still be used to control the costs associated with this processing. Indeed, if a queue of non-immediate requests exists, this queue may be flushed in response to the receipt immediate request, regardless of whether the queue has reached the threshold length that would normally trigger the flush. In this way, service instances in response to the queued requests can be clustered with the service instance in response to the immediate request, limiting the overall cost to the system.

A queuing system is just one method of scheduling the use of a service. Another is to provide clients in the set with hints that enable the client to request the service at a time that is optimum for limiting the overall system cost. This hint may, for example, include a time or a list of optimal times at which requests can be made. When the same times are provided to more than one client and the clients wait until those times before submitting requests, there will be a natural clustering of the requests and therefore instances of the service. The hint may include alternative conditions that, will be satisfied at an optimum times for the clients to submit their requests. For example, suitable conditions may include conditions that indicate current usage of the service by other clients. Importantly, the hints can be used to provide an indication to the client as to the best time to request the service—they do not necessarily restrict the client to requesting the service only at this time. Therefore, the client is free to request the service outside the optimum times, for example when the request is an immediate request such as a user-originating request.

In some embodiments, the fixed and incremental cost components and the set of clients are all determined by receiving this information from a knowledgebase. This knowledgebase, which may be present within the system or external to it, includes such information for a plurality of different services and may also include information relating to interrelations between the services. The contents of the knowledgebase may be static, but it is desirable that they be updated and this may be done by analysing services' use within the computer system and changing the information stored by the knowledgebase based upon this analysis.

The entry in the knowledgebase for a particular service can be created or updated by obtaining the fixed component of the cost associated with the use of the service; obtaining the incremental component of the cost associated with the use of the service; obtaining a set of clients to which the service is available; storing the obtained fixed cost component, incremental cost component and set of clients in the knowledgebase; and associating the stored fixed cost component, incremental cost component and set of clients in the knowledgebase with the service.

The fixed and/or incremental cost components associated with a first service's use may vary in dependence upon the use of other services, such that the cost components are greater or less when particular other services are being used. Such relationships can be stored in the knowledgebase, associated with one or more of the services affected by the relationship, and used when scheduling the use of those services. This allows the knowledgebase to be used as part of a framework to more efficiently schedule multiple interrelated services.

When multiple services are related in such a way that their fixed cost components can be shared amongst them, scheduling the use of one of these services may comprise scheduling its use so as to cluster instances of the service's use with the instances of the use of at least one of the services so related to it. This clustering may comprise scheduling the use of the services consecutively, or contemporaneously.

When multiple services are related in such a way that their cost components are adversely affected by the clustering of instances of their use, scheduling the use of one of the services may comprise scheduling use of the service to avoid clustering instances of the service's use with instances of the use of at least one of the services so related.

### BRIEF DESCRIPTION OF THE DRAWINGS

The present invention will now be described by way of example with reference to the accompanying drawings. In the drawings:

FIG. 1 is a schematic implementation of a mobile phone;

FIG. 2 is a schematic illustration of a network having two client devices and a service provider device;

FIG. 3 is an illustration of clustering multiple instances of a service's use;

FIG. 4 is an illustration of the clustering instances of multiple services' use;

FIG. 5 is an illustration of a queue for scheduling services' use;

FIG. 6 is an illustration of a queue for scheduling services' use;

FIG. 7 is a flow chart showing a method of scheduling a service's use; and

FIG. 8 is a flow chart showing a method of clustering a service's use.

### DETAILED DESCRIPTION OF THE INVENTION

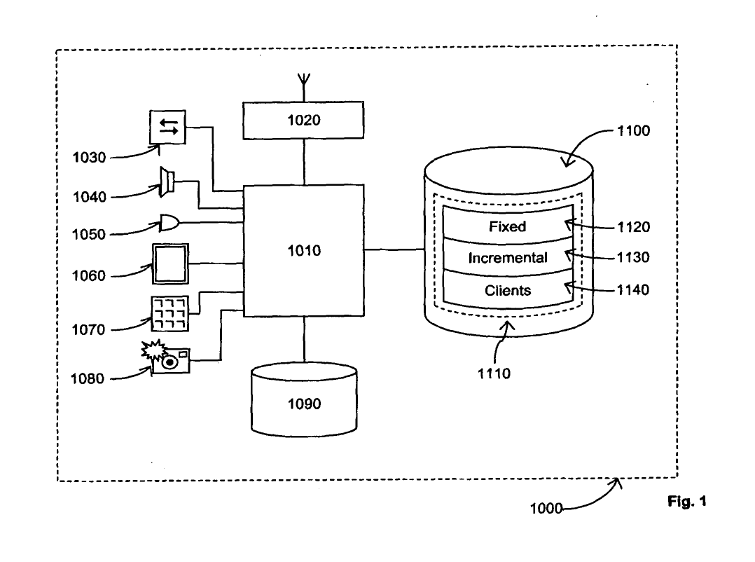

FIG. 1 illustrates a mobile phone 1000 that is configured to schedule the use of services in such a way as to limit the overall system cost. The phone 1000 comprises a Central Processing Unit (CPU) 1010 which is connected to a mobile phone transceiver 1020, a Wireless Local Area Network (WLAN) interface 1030; a speaker 1040; a microphone 1050; a display 1060; a user input device 1070; a camera 1080; Random Access Memory (RAM) 1090; and non-volatile storage memory 1100. The CPU 150 could be implemented on a single integrated circuit or distributed between multiple integrated circuits or other devices. The transceiver 1020 allows the phone 1000 to communicate with a mobile phone network. The user input device 1060 allows a user to interact with the phone 1000 and may include one or more of a keypad, a joystick, and a touch-sensitive element of the display 1060. The storage memory 1110 acts as a store for program instructions and other information, including instructions that implement an operating system when executed by the CPU 1010. The storage memory 1110 is preferably non-volatile and may be NAND flash memory. When instructions are to be executed by the CPU 1010, these instructions are first copied from the storage memory 1110 into the RAM 1090.

In operation, the phone 1000 runs under the control of the operating system. The operating system includes a software component that loads automatically when the phone 1000 is turned on. It controls the access of application programs that run on the phone 1000 to the hardware of the device, including their access to the memory 1090, 1110 of the phone 1000. The operating system is capable of preventing each application from accessing certain areas of the memory 1090, 1100 that are reserved for the operating system or for other applications. In contrast, components of the operating system may have unrestricted access to any areas of the memory 1090, 1100 that are accessible by the CPU 1010.

Within the storage memory 1100 of the phone is stored a knowledgebase 1110. The knowledge base 1110 includes, for each of one or more services offered by the phone's hardware or software, an indication 1120 of the fixed component of the cost associated with the use of the service, an indication 1130 of the incremental component of the cost associated with the use, and an indication 1140 of a set of clients that use the service. The indication 1140 of the set of clients may include details of the use of the service by the clients, for example the frequency and duration of use by the client, and the purpose of such use. The knowledgebase 1110 associates these indications 1120, 1130, 1140 with the service to which they relate.

In alternative embodiments the knowledgebase can instead be stored elsewhere in the phone—for example in the RAM 1090. The information it contains may be static, or may be updated dynamically—for example on the basis of measurements and observations made within the computer system.

In use, the indications 1120, 1130, 1140 stored in the knowledgebase 1110 are used to schedule the use of the service in such a way as to limit the overall system cost. This scheduling is preferably performed by the operating system running on the phone 1000, but may be performed elsewhere—for example in dedicated hardware.

The concept of using a knowledgebase to schedule the use of services is useful in the context of mobile phones and other mobile computing devices since certain costs (especially power consumption and performance) are acutely important in such devices. However, it is generally desirable to limit the overall cost in computer systems in general and scheduling the use of services in order to achieve this therefore has a wider application than just mobile computing devices.

It is, likewise, not essential that the computer system comprises just a single device/apparatus, such as the phone 1000 of FIG. 1. In alternative embodiments some or all of the service provider, the client, the knowledgebase, and the component performing the scheduling may be located in different devices within an overall system.

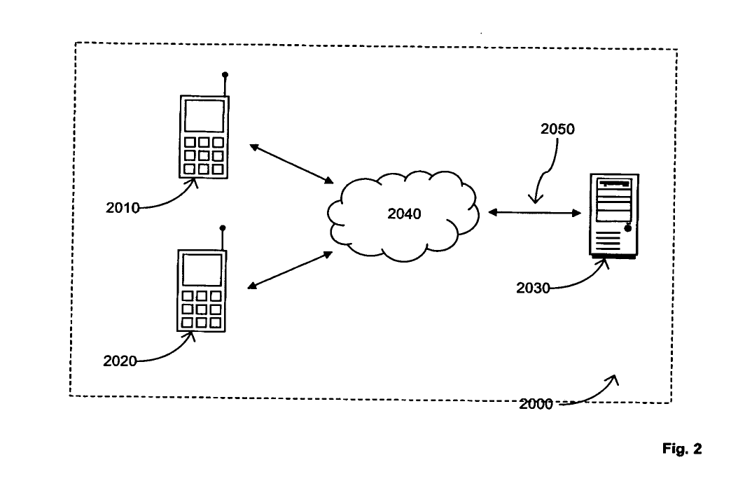

FIG. 2 shows a computer system 2000 comprising two client devices 2010, 2020 connected to a server device 2030 across a communication network 2040. Here, the server 2030 acts as a service provider, providing a service to client devices 2010, 2020. Use of the service by the client devices 2010, 2020 is scheduled to limit the overall cost to the system 2000. This scheduling may be performed by the server 2030 using a knowledgebase local to the server 2030 or accessible from it, Performing the scheduling at the service provider (server 2030) facilitates scheduling of the service, since the connections across the network 2040 may not be reliable or permanent (e.g. in a WLAN). However, scheduling can instead be coordinated at any point in the system 2000—for example by an intermediate device inserted in the connection between the server 2050 and the network 2040. The intermediate device may include the knowledgebase and act to block or delay requests from the client devices 2010, 2020 to effect the scheduling in a way that is transparent to the other devices 2010, 2020, 2030. Use of an intermediate device in this way has the advantage of permitting some embodiments that use knowledgebase-based scheduling to be retrofitted to an existing system without requiring modification of the other devices in the system.

In some embodiments, the overall system cost is the overall cost to a system including both the clients and the service provider. However, this is not necessarily the case. For example, the notional ‘computer system’ in FIG. 2 may instead comprise just the server 2030 and exclude the client devices 2010, 2020 and the communication network 2040, as shown by box 2060. Requests from the client devices 2010, 2020 would then be scheduled so as to minimise the overall system cost to the server 2030 (i.e. to just the notional computer system 2060), regardless of the consequential cost to the client devices 2010, 2020.

FIG. 7 illustrates the basic operation of the cost-based scheduling technique. As illustrated, the fixed cost, incremental cost and clients of a service are determined in that order, however these three determinations could in practice be performed in any order (or simultaneously). Once the determinations have been made, the use of the service is scheduled based upon those determinations.

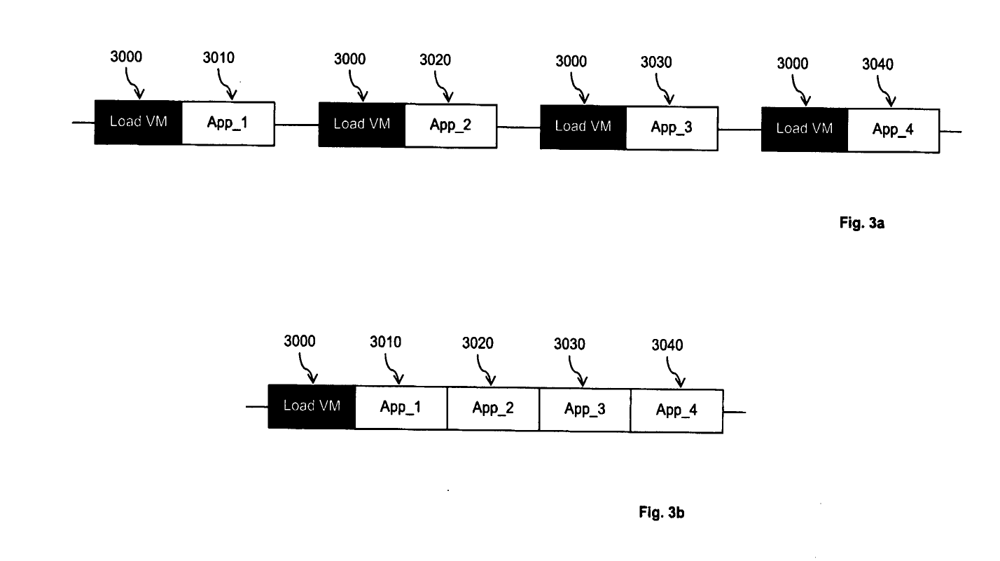

FIG. 3 illustrates the effect of scheduling the use of a service by clustering multiple instances of the service together.

FIG. 3a shows a timeline of four separate discrete instances of the use of a service for loading Java applications. Java applications are written run by a virtual machine which is itself is a program run on the host computing device. Loading a Java application therefore requires the Java virtual machine to be running. The service illustrated in FIG. 3a is used on four separate occasions in order to load each of applications APP 1, APP 2, APP 3, and APP 4. Each of the four instances of the service's use actually comprises two stages: first the service loads the Java virtual machine 3000, then the service loads the Java application itself 3010, 14 3020, 3030, 3040. The step of loading the virtual machine 3000 contributes a fixed cost since it must always be performed prior to loading the application, and does not vary according to the application being loaded. However, loading the application itself 3010, 3020, 3030, 3040, contributes an incremental cost since the cost of this step depends on the particular application being loaded (i.e. large and complex applications will be normally more costly to load than small and simple applications).

Loading the Java virtual machine is costly in terms both of power consumption and of system performance. Loading the virtual machine on four separate occasions as illustrated in FIG. 3a therefore significantly contributes to the overall system cost. However, it so happens that only one instance of the Java virtual machine need be loaded in order to load and run multiple Java applications, so long as the virtual machine is not terminated between the loads. Scheduling use of the application loading service in order to cluster instances of the service's use can take advantage of this knowledge in order to minimise the overall cost to the system.

FIG. 3b illustrates the use of the Java application loading service to load the same four applications as in FIG. 3a. However, in FIG. 3b knowledge of the clients of the load service and the fixed and incremental cost components of the service's use have been used to schedule the four instances so as to form a cluster. The service instances are illustrated as consecutive in FIG. 3b, but could in reality be contemporaneous (i.e. the stages of actually loading the applications 3010, 3020, 3030, 3040 could be performed simultaneously, rather than one immediately after the other). Clustering the instances allows a single load of the virtual machine 3000 to be shared between all four instances, reducing the associated fixed costs by 75%. This represents a significant saving in terms of overall system cost.

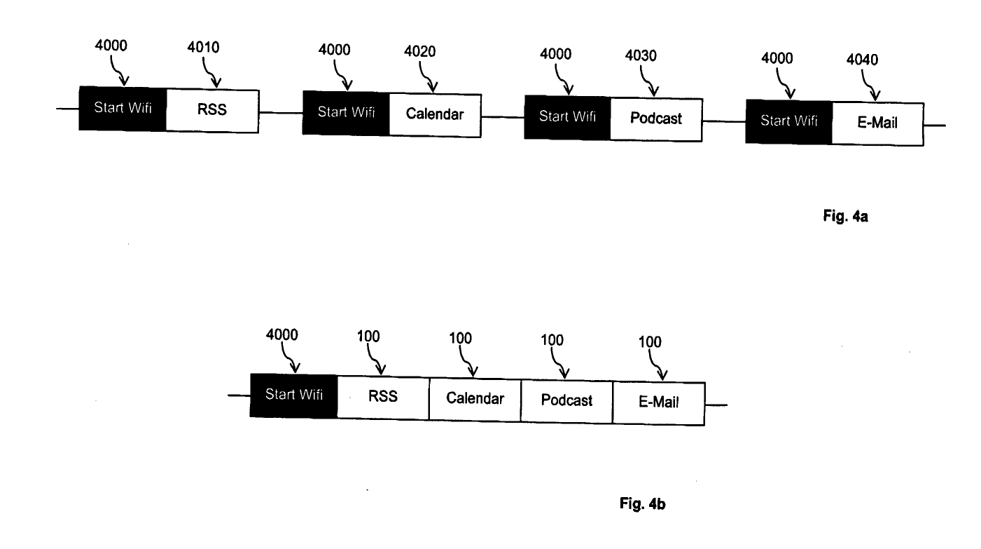

FIG. 4 illustrates a clustering arrangement where four different services are scheduled so as to minimise the overall system cost. The four services relate 15 to downloading RSS feeds, synchronising local and remote calendars, uploading a podcast to a server, and sending an e-mail message.

FIG. 4a shows a single instance of each of the four services performed separately. Although each of the four services is different, they all have associated fixed and incremental costs. A feature that all four services have in common is that they are performed over a WLAN and involve the step of initiating a WiFi internet connection 4000. Similar to the loading of the virtual machine in the previous example, the initialisation of the Wifi connection four times represents a significant fixed cost. The steps 4010, 4020, 4030, 4040 of the services that follow the initiation of the Wifi connection are specific to the particular service being performed and cannot be combined. The subsequent steps 4010, 4020, 4030, 4040 although not combinable with the instances of different services may well have fixed cost components that can be shared across services of the same type. For example, step 4040 involves connecting to an e-mail server and sending a first e-mail and will involve fixed cost components relating to establishing a connection to the e-mail server. The establishment of the connection to the e-mail server is a step that can be combined with a separate instance of the service in which a second e-mail is to be sent; however it is not possible to combine this step with unrelated services such as updating RSS feeds, synchronising calendars and uploading podcasts.

Because an indication of the relationship between the services of FIG. 4 is stored in the knowledgebase, use of the four different services can be scheduled based upon both this and the knowledge of their fixed and incremental cost components, and use by clients. In the present case, the information in the knowledgebase can be used to determine that a reduction in the overall system cost can be obtained by clustering instances of the four services together to share at least some of their common fixed cost components. When the four instances are clustered as illustrated in FIG. 4b, a single WiFi internet connection can be established 4000 and shared between all four instances, representing a 75% saving in the associated costs.

There are numerous different ways in which the clustering-based scheduling can be performed. One method is to queue requests for services and to flush the queue so as to release all the queued requests for processing at substantially the same time. This embodiment can be implemented transparently to the service provider and client, This makes it very suitable for embodiments where the scheduling functionality is retrofitted to an existing computer system with minimal or no change to the existing clients and service providers.

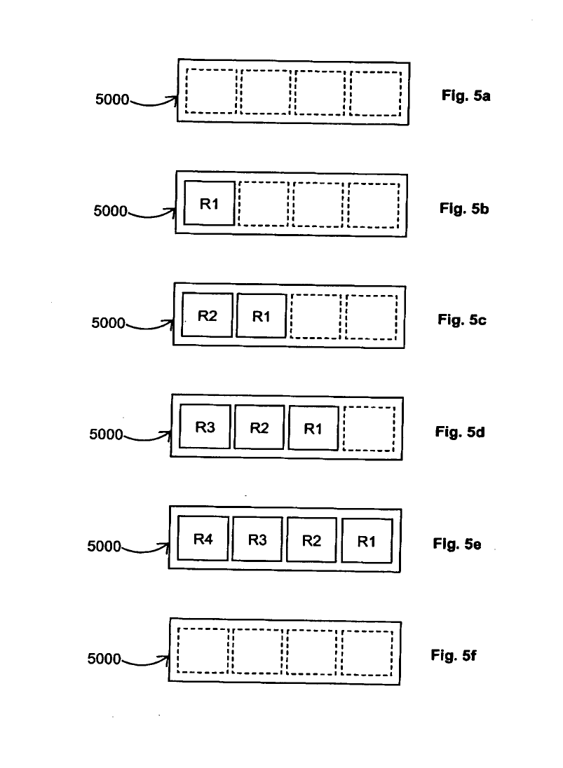

FIG. 5 illustrates the operation of a possible queuing method for scheduling a service. The queue 5000 shown in FIG. 5 has a maximum capacity of just four requests. This number has been chosen by way of example, and the choice of queue length can be chosen according to the nature of the system and, optionally, the service scheduled.

FIG. 5a shows the queue 5000 empty. FIGS. 5b-5d show the receipt and queing of the first three requests for the service, R1-R3. On receipt of the 4th request, R4, the queue 5000 is filled (FIG. 5e). The system is configured to flush the queue once it is it filled, and all four requests, R1-R4, are released to the service provider at substantially the same time. As a consequence, the four requests will be processed as a cluster of instances of the service's use.

In the description above, R1-R4 are requests for the same service. However, where a relationship exists between a plurality of services such that their costs can be shared through clustering, the queue 5000 could hold requests for any of the related services. Alternatively, requests for each of the related services may be held in a different queue and all the queues flushed simultaneously once a predetermined condition is met (for example the filling of one of the queues, or the total number of requests across all the queues exceeding a threshold number).

Queuing the requests as described above works best when that none of the queued requests are time sensitive and that they can be delayed as required in order to best limit the overall system cost. However, this is often not the case. Consider, for example, a service used to retrieve RSS feeds from a remote server. When a request is intermittently made to use this service in order to automatically update information displayed in a news headline ticker, it is not essential that the request be processed immediately. Queuing the request until the queue 5000 has been filled and flushed may delay the most up-to-date news content being displayed on the ticker, but this is unlikely to unduly inconvenience the user. The same may not be true of a user-originating request for the same news feed, perhaps from a browser or dedicated feed reader application. A user requesting the feed will not wish to wait a long time for his request to be processed, even if this reduces the overall cost to the system. In some embodiments this is overcome is solved by distinguishing between requests that require immediate processing (for example user-originating requests) and requests that do not. This distinction may be made in the request itself.

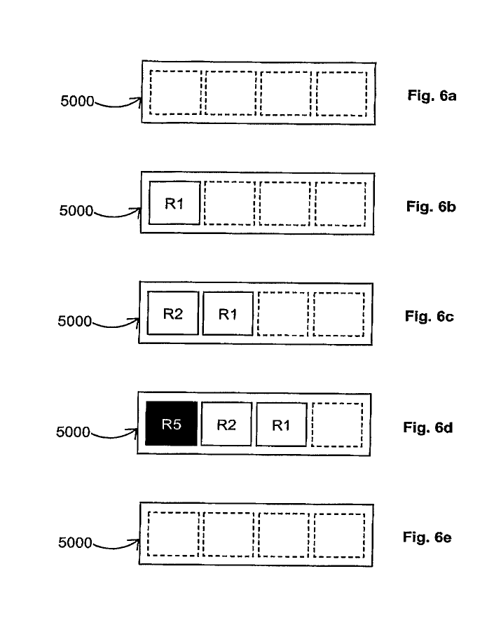

FIG. 6 shows the operation of a queue in the scenario where a request is issued that requires immediate processing. FIG. 6a illustrates the empty queue 5000. FIGS. 6b and 6c show the queue 5000 storing non-immediate requests R1 and R2 as they are received. However, in FIG. 6d a request R5 has been received that requires immediate processing. Although R5 requires immediate processing, it is desirable to cluster its processing with requests A1 and R2 in order to limit the overall cost to the system. Therefore, the queue 5000 is flushed on receipt of the immediate request R5, even though it is not yet full.

In practice, the queue is not necessarily flushed in the order in which the requests are received. In particular, an immediate request may be released from the queue first, in order that it will be processed as soon as possible and ahead of other requests in the queue. Alternatively, immediate requests may not be added to the queue at all, but instead processed immediately (and the queue of non-immediate requests flushed).

FIG. 8 illustrates an exemplary queuing technique for clustering service use, which supports the immediate handling of urgent (immediate) requests. On the reception of a new request, a decision is made as to whether or not the request is urgent. If the request is urgent then it is processed immediately, after which the queue is flushed regardless of its size (to cluster the processing of any queued requests with the processing of the immediate request). If the received request is not urgent, it is simply added to the queue and the queue is then processed only if it has reached a predetermined maximum length. The next request is then awaited.

Rather than (or in addition to) using a queue, the use of services may be scheduled using hints provided to the clients. A ‘hint’ is an indication as to the optimal time for the clients to issue requests for the service in order to limit the overall system cost.

In a crude embodiment, hints are intermittently issued to the clients and each contain an arbitrary time. The clients preferably wait for that time to issue service requests. A natural cluster of service instances is consequently formed at the arbitrary time, as the various clients issue their backlog of requests.

In a more advanced embodiment, the time in the hint is not arbitrary, but is chosen to be a time when services can be used at a lower cost, or demand upon the service provider is expected to be low.

Rather than including an explicit time for the clients to issue requests, the hint may include other conditions that, when satisfied, indicate that the optimum time has occurred. In particular, these conditions may relate to the availability of system resources and/or current demand upon the service provider.

The hints may be issued by the service provider, or by a separate entity performing the scheduling. In other embodiments, the clients themselves may issue hints to other clients within the set. This is particularly effective since clients will often have advance knowledge of future requests they is likely to make and can cooperate to issue the requests together, clustering the resulting service usage.

A hint-based scheduling embodiment is well suited for scheduling services that are subject to both immediate and non-immediate requests, since the hints merely indicate to the clients when a request may optimally be issued. The clients are not prohibited from issuing requests at times that do not correspond to a received hint and can therefore issue immediate requests right away. Indeed, a hint may be issued by a client when it issues an immediate request, inviting the other clients to issue their own requests right away in order to create a cluster around the immediate request.

The description so far has concentrated on scheduling the use of services so as to minimise the overall system cost. However, other forms of limitation may also be used. In particular, it is in some cases desirable to maintain a cost below a particular threshold level, but not crucial that it be minimized below the threshold. For example, the efficiency of some batteries can be improved by preventing the power consumption from rising above a particular level. Below this level, the actual power consumption is less important. A further example is that of a renewable energy source such as a photovoltaic cell, where the power consumption of system may need to be kept within the capabilities of the energy source, but the extent to which available power is consumed below this level is of little consequence.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present invention may consist of any such feature or combination of features. In view of the foregoing description it will be evident to a person skilled in the art that various modifications may be made within the scope of the invention.

1. A method comprising:
determining a fixed component of the cost associated with the use of a service in a computer system;
determining an incremental component of the cost associated with the use of the service;
determining a set of clients to which the service is available; and
using the determined fixed and incremental components to schedule use of the service by the set of clients so as to control the overall system cost.

2-22. (canceled)

23. Apparatus comprising:
at least one processor; and
at least one memory including computer program code,
the at least one memory and the computer program code are configured to, working with the at least one processor, cause the apparatus to perform at least the following:
determine a fixed component of the cost associated with the use of a service in a computer system;
determine an incremental component of the cost associated with the use of the service;
determine a set of clients to which the service is available; and
use the determined fixed and incremental components to schedule use of the service by the set of clients so as to control the overall system cost.

24. (canceled)

25. The apparatus of claim 23, wherein scheduling use of the service comprises clustering multiple instances of the service so as to share the fixed cost component across the clustered instances.

26. The apparatus of any of claim 23, wherein limiting the overall system cost comprises minimising the overall system cost.

27. The apparatus of claim 23, wherein limiting the overall system cost comprises maintaining the overall system cost below a threshold level.

28. The apparatus of claim 23, wherein the cost comprises one or more of: power consumption; a reduction in the remaining usable life of an energy store; and heat generation.

29. The apparatus of claim 23, wherein the cost comprises one or more of: processor time; memory usage; and communication bandwidth usage.

30. The apparatus of claim 23, wherein the cost comprises a financial cost.

31. The apparatus of claim 23, wherein scheduling use of the service comprises queuing requests for the service from the clients.

32. The apparatus of claim 23, wherein the scheduling use of the service further comprises flushing the queue when the number of requests in the queue exceeds a threshold number.

33. The apparatus of claim 31, wherein scheduling the use of the service further comprises flushing the queue when the total cost of flushing the queue exceeds a predetermined threshold cost.

34. The apparatus of claim 31, wherein scheduling the use of the service further comprises flushing the queue when a request for the service is received that requires immediate performance.

35. The apparatus of claim 23, wherein scheduling the use of the service comprises providing at least one of the set of clients with a hint enabling the client to request the service at an optimum time.

36. The apparatus of claim 35, wherein the hint comprises a set of conditions which will be met at the optimum time for requesting the service.

37. The apparatus of claim 23, wherein determining the fixed cost component, determining the incremental cost component, and determining the set of clients comprise receiving those data from a knowledgebase.

38. The apparatus of claim 37, wherein the knowledgebase contains, associated with each of a plurality of services whose use contributes to the overall system cost:
a fixed component of the cost associated with the use of that service;
an incremental component of the cost associated with the use of that service; and
a set of clients to which that service is available.

39. The apparatus of claim 38, wherein the at least one memory and the computer program code are further configured to, working with the at least one processor, cause the apparatus to perform at least the following:
obtain the fixed component of the cost associated with the use of a service;
obtain the incremental component of the cost associated with the use of the service;
obtain a set of clients to which the service is available;
store the obtained fixed cost component, incremental cost component and set of clients in the knowledgebase; and
associate the stored fixed cost component, incremental cost component and set of clients in the knowledgebase with the service.

40. The apparatus of claim 38, wherein:
a relationship exists between a first and a second service, such that at least one of the fixed and incremental cost components of either service
varies in dependence upon the use of the other service;
the knowledgebase contains said relationship, associated with the first service; and
scheduling the use of the first service further comprises using said relationship to limit the overall system cost.

41. The apparatus of claim 40, wherein scheduling use of the first service comprises clustering at least one instance of the first service and at least one instance of the second service, so as to share at least a portion of the fixed cost components of the clustered instances.

42. The apparatus of claim 40, wherein scheduling use of the first service comprises avoiding clustering of instances of both the first service and second service.

43. (canceled)

44. The apparatus of claim 23 comprising a mobile telephone.

45-46. (canceled)

47. A computer readable medium, having stored thereon a program comprising instructions for:
determining a fixed component of the cost associated with the use of a service in a computer system;
determining an incremental component of the cost associated with the use of the service;
determining a set of clients to which the service is available; and
using the determined fixed and incremental components to schedule use of the service by the set of clients so as to control the overall system cost.
